(19) United States
(12) Patent Application Publication
(10) Pub. No.: US 2015/0358366 A1
(43) Pub. Date: Dec. 10, 2015

(54) Method and Apparatus for Keeping Alive L2TP Tunnel State

(71) Applicant: ZTE CORPORATION, Shenzhen, Guangdong (CN)

(72) Inventors: Qiandeng LIANG, Shenzhen (CN); Liang FAN, Shenzhen (CN); Yong CHEN, Shenzhen (CN)

(21) Appl. No.: 14/760,243

(22) PCT Filed: Sep. 12, 2013
(86) PCT No.: PCT/CN2013/083392

§ 371 Date: Jul. 10, 2015

(30) Foreign Application Priority Data
Jan. 11, 2013 (CN) 201310010235.4

(51) Int. Cl. H04L 29/06

(52) U.S. Cl. CPC H04L 65/1069

(57) ABSTRACT

A method and apparatus for keeping alive an L2TP tunnel state are provided, where the method includes: an active device and an opposite-end device establish an L2TP tunnel, the active device transmits to a standby device an interactive L2TP control message between the active device and the opposite-end device, and the active device performs corresponding processing on the L2TP control message only after having received a response about having stored the L2TP control message sent by the standby device; and when active-standby switching occurs between the active device and the standby device, the standby device connects to the opposite-end device via the L2TP tunnel, and performs corresponding processing according to the L2TP control message which has already been stored. Control messages of an active and standby device and an opposite-end device of the disclosure always keep synchronous, ensuring that when the active device has failed, after switching between the active and standby device, the standby device and the opposite-end device can work normally, which will not cause discarding of the message, and ensuring the normal working state.

### TECHNICAL FIELD

The embodiments of the disclosure relate to the technical communication field, and in particular, to a method and an apparatus for keeping alive an L2TP tunnel state.

### BACKGROUND

The prior art supports backup of a layer two tunneling protocol (i.e., Layer 2 Tunneling Proto, L2TP for short) accessing an L2TP concentrator (i.e., L2TP Access Concentrator, LAC for short) or an L2TP network server (LNS for short), and information about an L2TP user and an L2TP tunnel as well as a session is backed up between active and standby LAC devices or active and standby LNS devices, and a backup message is sent via a direct connection link or an up and down layer network link. Since each tunnel serial number continuously changes with interaction of a control message, a tunnel serial number in a backup message and a tunnel control message serial number occurred at the same time cannot realize real-time synchronization. A device A sends a tunnel message serial number X between the device A and a device B to a backup device C thereof through the backup message. When the device B receives the message and identifies and stores a “current” serial number, at an device A side, because a user goes on and off line or an opposite-end Hello message has updated a current practical serial number to X+1 or X+2 or even a more larger serial number, and now if a device malfunction occurs and active and standby devices switching is caused to occur, then a serial number of a device B side and a serial number of a device C side do not realize real-time synchronization. Now if the device C sends a tunnel control message to a the device B, the device B will be caused to discard a tunnel control message sent by the device C and at the same time, actively dismantle the L2TP tunnel and cause all users in the tunnel to go off line. In addition, if the device C waits for a control message or hello message of the device B, then a control message of the device C may be caused to be unable to be sent and influence normal on and off line of a user.

### SUMMARY

Based on the above-mentioned analysis, the embodiments of the disclosure aim to provide a method and an apparatus for keeping alive an L2TP tunnel state so as to solve the problem of working state being chaotic caused by switching of an active device or a standby device.

The object of the embodiments of the disclosure is mainly implemented through the following technical solutions:

A method for keeping alive an L2TP tunnel state, wherein the method includes:

an active device establishes an L2TP tunnel with an opposite-end device, the active device transmits to the standby device an interactive L2TP control message between the active device and the opposite-end device, and the active device performs corresponding processing on the L2TP control message only after having received a response about having stored the L2TP control message sent by the standby device;

and when active-standby switching occurs between the active device and the standby device, the standby device connects to the opposite-end device via the L2TP tunnel, and performs corresponding processing according to the L2TP control message which has already been stored.

Preferably, the step of an active device establishing an L2TP tunnel with an opposite-end device specifically includes:

the active device sends to the standby device a request for establishing the L2TP tunnel with the opposite-end device;

the standby device receives and stores the request sent by the active device, and sends to the active device a response about having stored the request;

and after receiving a response about having stored the request sent by the standby device, the active device sends the request to the opposite-end device, and after receiving information about having successfully established the L2TP tunnel sent by the opposite-end device, sends the information to the standby device for storing.

Preferably, the active device transmits to the standby device an interactive L2TP control message between the active device and the opposite-end device, and the step of the active device performing corresponding processing on the L2TP control message only after having received a response about having already stored the L2TP control message sent by the standby device specifically includes:

the active device sending to the standby device the interactive L2TP control message between the active device and the opposite-end device;

after receiving and storing the L2TP control message sent by the active device, the standby device sending to the active device a response about having stored the L2TP control message;

and the active device then performing corresponding processing on the L2TP control message after receiving the response.

Preferably, the active device is an L2TP access concentrator or an L2TP network server; and the standby device is an L2TP access concentrator or an L2TP network server.

Preferably, each of the L2TP control messages carries a corresponding serial number.

Preferably, the standby device updates states of the L2TP tunnel and a session on the standby device, when the standby device stores the L2TP control message sent by the active device.

The embodiments of the disclosure further provide an apparatus for keeping alive an L2TP tunnel state, including:

an active device, configured to establish an L2TP tunnel with an opposite-end device, and transmit to the standby device an interactive L2TP control message between the active device and the opposite-end device, and perform corresponding processing on the L2TP control message only after having received a response about having already stored the L2TP control message sent by the standby device;

and the standby device, configured to the active device a response about having stored the L2TP control message after receiving and store the L2TP control message sent by the active device, and when active-standby switching occurs between the standby device and the active device, connect to the opposite-end device via the L2TP tunnel, and perform corresponding processing according to the L2TP control message which has already been stored.

Preferably, the active device, further configured to send to the standby device a request for establishing the L2TP tunnel with the opposite-end device, and after receiving a response about having stored the request sent by the standby device, sending the request to the opposite-end device, and after receiving information about having successfully established the L2TP tunnel sent by the opposite-end device, send the information to the standby device, and receive a response about the standby device having stored the information;

and the standby device, further configured to send to the active device a response about having stored the request after receiving and storing the request sent by the active device, and sending to the active device a response about having stored the information after receiving and storing information about having successfully established the L2TP tunnel sent by the active device.

Preferably, the active device is an L2TP access concentrator or an L2TP network server; and the standby device is an L2TP access concentrator or an L2TP network server.

Preferably, the each of the L2TP control messages carries a corresponding serial number.

Preferably, the standby device, further configured to update states of the L2TP tunnel and a session on the standby device, when the standby device stores the L2TP control message sent by the active device.

The embodiments of the disclosure have the beneficial effects as follows:

The embodiments of the disclosure provide a method and apparatus for keeping alive an L2TP tunnel state, and through the process of an active device establishing an L2TP tunnel with an opposite-end device, and before the active device sends to the opposite-end device an L2TP control message, or before the active device processing the L2TP control message sent by the opposite-end device, the active device will always send to the standby device an L2TP control message with a serial number, and after storing the L2TP control message, the standby device then returns the L2TP control message to an active and standby device, and after receiving the L2TP control message, the active device and the standby device then perform other processing, that is, control messages of an active device and an opposite-end device in the embodiments of the disclosure always keep synchronous, ensuring that after switching between the active and standby device, the standby device and the opposite-end device can work normally, which will not cause discarding of the message, and ensuring the normal working state.

Other features and advantages of the embodiments of the disclosure will be described in the following description and partly become obvious from the description, or be understood by implementing the disclosure. The objects and other advantages of the disclosure can be realized and obtained through the structures indicated by the description, claims and drawings.

### BRIEF DESCRIPTION OF THE DRAWINGS

FIG. 1 shows an example flowchart of a method for keeping alive an L2TP tunnel state according to embodiment 1 of the disclosure;

FIG. 2 shows an example schematic diagram of a method for establishing an L2TP tunnel D between active and standby LACs and LNSs according to embodiment 1 of the disclosure;

FIG. 3 shows an example schematic diagram of a method for keeping alive an L2TP tunnel state established by an active and standby device and an opposite-end device according to embodiment 1 of the disclosure;

FIG. 4 shows an example schematic diagram of establishing a method for keeping alive an L2TP tunnel state between LAC and active and standby LNSs according to embodiment 1 of the disclosure.

### DESCRIPTION OF EMBODIMENTS

Preferred embodiments of the disclosure will be described below in detail in conjunction with the drawings, wherein drawings form a part of the application and are used to explain the principles of the disclosure together with embodiments of the disclosure.

### Embodiment 1

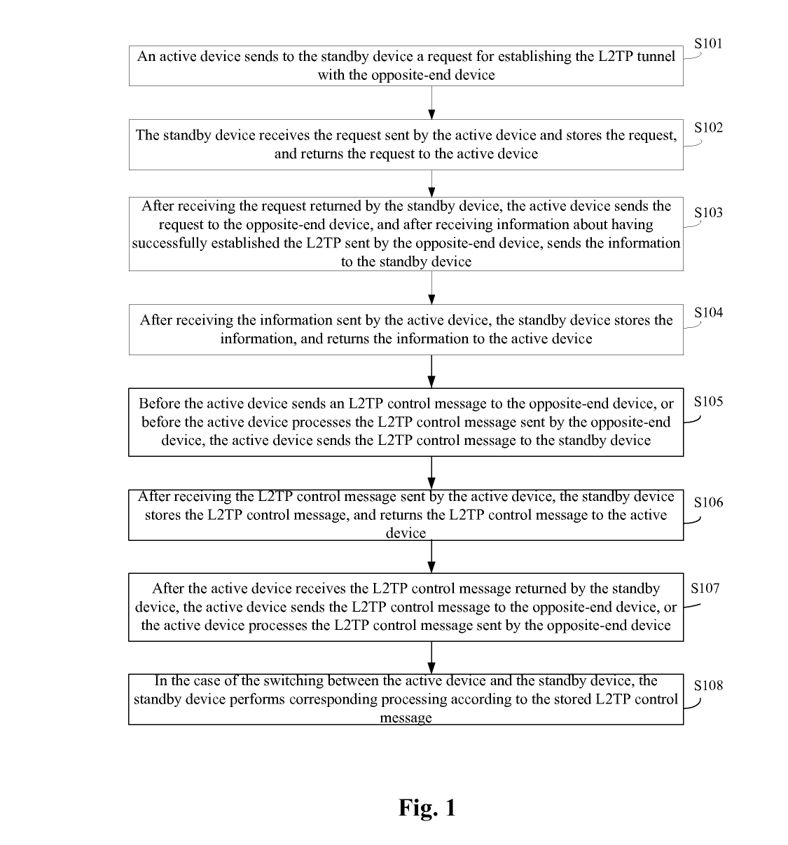

The embodiment of the disclosure provides a method for keeping alive an L2TP tunnel state, as shown in FIG. 1, the method includes:

S101. An active device sends to the standby device a request for establishing the L2TP tunnel with the opposite-end device,

wherein the active device and the standby device respectively are an L2TP access concentrator (LAC for short) and an L2TP network server (LNS for short).

S102. The standby device receives the request sent by the active device and stores the request, and returns the request to the active device;

S103. After receiving the request returned by the standby device, the active device sends the request to the opposite-end device, and after receiving information about having successfully established the L2TP sent by the opposite-end device, sends the information to the standby device;

S104. After receiving the information sent by the active device, the standby device stores the information, and returns the information to the active device;

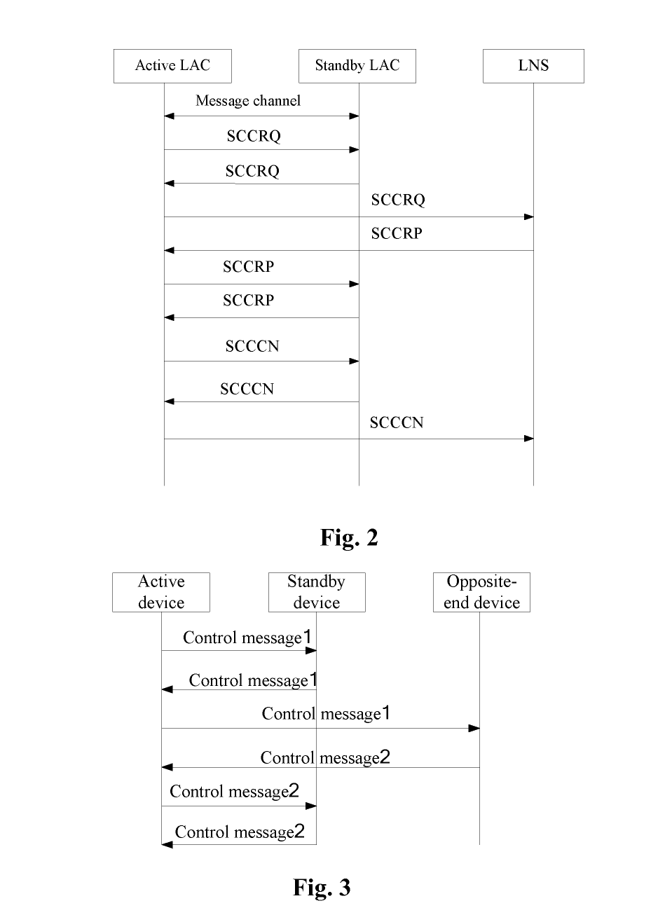

The embodiment of the disclosure provides a method for establishing an L2TP tunnel between active and standby LACs and LNSs, as shown in FIG. 2, and the method includes:

step A1, a TCP connection is established between an active LAC and a standby LAC for transmitting an L2TP control message;

step A2, the active LAC encapsulates an SCCRQ (Start-Control-Connection-Request, a tunnel establishment request) message (being used for sending to the LNS an L2TP tunnel establishment request);

step A3, the active LAC sends an encapsulated SCCRQ message to the standby LAC via a message channel between active and standby LACs;

step A4, after receiving the SCCRQ message, the standby LAC stores same and updates a locally standby tunnel state, and sends the SCCRQ message back to the active LAC;

step A5, the active LAC sends to an LNS the SCCRQ message which is sent back by the standby LAC;

step A6, the LNS sends an SCCRP (Start-Control-Connection-Reply, an L2TP tunnel establishment response) message to the active LAC;

step A7, the active LAC sends the received SCCRP message to the standby LAC via a message channel between active and standby LACs;

step A8, after receiving the SCCRP message, the standby LAC stores same and updates a locally standby tunnel state, and sends the SCCRP message back to the active LAC;

step A9, the active LAC processes the SCCRP message which is sent back by the standby LAC;

step A10, the active LAC encapsulates an SCCCN (Start-Control-Connection-Connected, tunnel establishment success) message (being used for sending to the LNS a response of tunnel establishment success);

step A11, the active LAC sends an encapsulated SCCCN message to the standby LAC via a message channel between active and standby LACs;

step A12, after receiving the SCCCN message, the standby LAC stores same and updates a locally standby tunnel state, and sends the SCCCN message back to the active LAC;

step A13, the active LAC sends to an LNS the SCCCN message which is sent back by the standby LAC.

The embodiment of the disclosure synchronizes the situation of establishing an L2TP tunnel between an active and standby device pair and an opposite-end device, ensuring that after switching between the active device and the standby device, the standby device and the opposite-end device can work normally, which will not cause discarding of the message, and ensuring the normal working state.

S105. Before the active device sends an L2TP control message to the opposite-end device, or before the active device processes the L2TP control message sent by the opposite-end device, the active device sends the L2TP control message to the standby device;

Each control message between the opposite-end device and the active and standby device of the embodiment of the disclosure is provided with a serial number, and the serial number includes Ns (Number Send, a serial number of sending a message this time) and Nr (Next Receive, a serial number of a message expected to be received next time). In this way, before the active device sends to the opposite-end device an L2TP control message, or before the active device processing the L2TP control message sent by the opposite-end device, the active device will always send to the standby device an L2TP control message with a serial number, and after storing the L2TP control message, the standby device then returns the L2TP control message to an active and standby device, and after receiving the L2TP control message, the active and standby device then performs other processing, that is, control messages of an active and standby device and an opposite-end device in the embodiments of the disclosure always keep synchronous, this ensuring that when the malfunction of the active device accrues, after switching between the active device and the standby device, the standby device and the opposite-end device can work normally, which will not cause discarding of the message, and ensuring the normal working state.

S106. after receiving the L2TP control message sent by the active device, the standby device stores the L2TP control message, and returns the L2TP control message to the active device;

In the embodiment of the disclosure, the standby device updates states of the L2TP tunnel and a session on the standby device, when the standby device stores and returns the L2TP control message of the active device.

S107. After the active device receives the L2TP control message returned by the standby device, the active device sends the L2TP control message to the opposite-end device, or the active device processes the L2TP control message sent by the opposite-end device;

S108. in the case of the switching between the active device and the standby device, the standby device performs corresponding processing according to the stored L2TP control message.

In the embodiment of the disclosure, the active device, the standby device and the opposite-end device real-time monitor network connectivity of an L2TP tunnel established between the active device and the opposite-end device. When the L2TP tunnel is monitored to have failed, the standby device switches with the active device, and certainly the person skilled in the art also may use another manner to monitor the L2TP tunnel.

Monitoring the network connectivity of the L2TP tunnel used in the embodiment of the disclosure specifically is:

when the active device monitors that a failure occurs in the L2TP tunnel between itself and the opposite-end device (for example, two end devices of an L2TP tunnel, i.e. an active device and an opposite-end device, starting BFD detection (bidirectional forwarding detection), accelerating a failure sensing speed), the standby device is triggered to switch with itself;

Or,

when the standby device detects that the active device is invalid (for example, starting the BFD detection between the active device and the standby device, the standby device detecting that the active device has a failure through the BFD detection), then it may be determined that a failure occurs in the L2TP tunnel between the active device and the opposite-end device, triggering the standby device and the active device to switch.

The embodiment of the disclosure further provides a method for keeping alive the state of the L2TP tunnel established by the active and standby device and the opposite-end device. it can be seen from FIG. 3 that before sending the L2TP control message to the opposite-end device, the active device firstly sends to the standby device the L2TP control message with a serial number, and a standby message stores the L2TP control message after receiving the L2TP control message, and then returns the L2TP control message to the active device. The active device sends the L2TP control message to the opposite-end device after receiving the L2TP control message returned by the standby device, and the opposite-end device then sends another L2TP control message to the active device after receiving the L2TP control message. The method ensures that L2TP control messages of the active and standby device and the opposite-end device always keep synchronous.

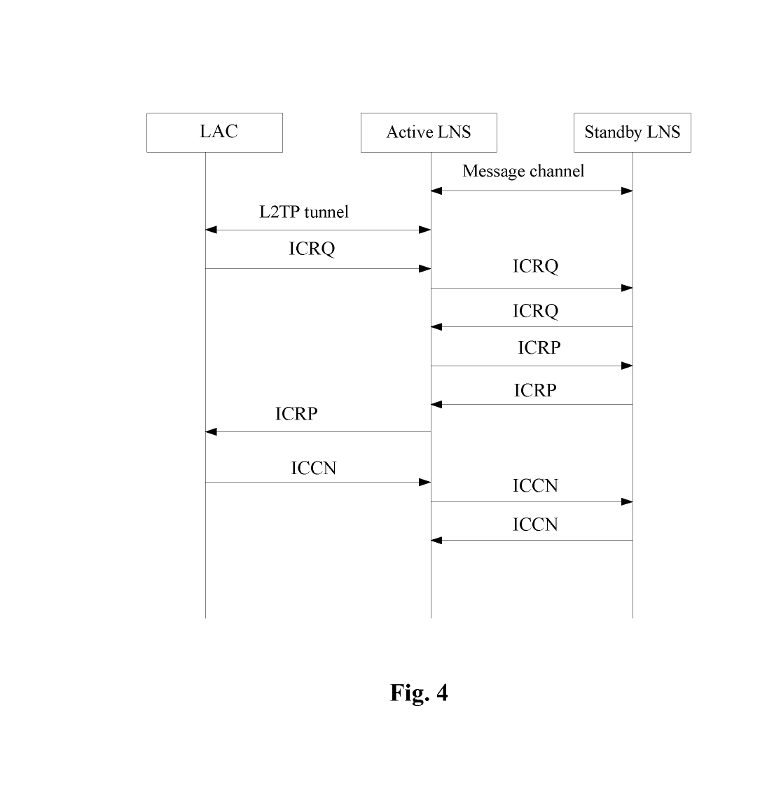

The embodiment of the disclosure further provides a method for keeping alive the state of an L2TP tunnel established between an LAC and active and standby LNSs, as shown in FIG. 4, the method includes:

step B1, a TCP connection is established between an active LNS and a standby LNS for transmitting an L2TP control message;

step B2, an L2TP tunnel is established between the active LNS and the LAC device, and see step A1 to step A13 for details about the process for establishing the L2TP tunnel;

step B3, the LAC sends an ICRQ (Incoming-Call-Request, a session establishment request) message to the active LNS;

step B4, the active LNS sends the received ICRQ message to the standby LNS via a message channel between active and standby LNSs;

step B5, after receiving the ICRQ message, the standby LNS stores the message and updates a locally standby session state, and sends the ICRQ message to the active LNS;

step B6, the active LNS processes the ICRQ message sent back by the standby LNS;

step B7, the active LNS encapsulates an ICRP (Incoming-Call-Replay, a session establishment response) message (being used for sending a tunnel establishment response to the LAC);

step B8, the active LNS sends the encapsulated ICRP message to the standby LNS via a message channel between active and standby LNSs;

step B9, after receiving the ICRP message, the standby LNS stores information about Ns, Nr and so on and updates a locally standby session state, and sends the ICRP message back to the active LNS;

step B10, the active LNS sends to the LAC the ICRP message sent back by the standby LNS;

step B11, the LAC sends an ICCN (Incoming-Call-Connected, session establishment success) message to the active LNS (being used for sending a session establishment success acknowledgement to an LNS);

step B12, the active LNS sends the received ICCN message to the standby LNS via a message channel between active and standby LNSs;

step B13, after receiving the ICCN message, the standby LNS stores information about Ns, Nr and so on and updates a locally standby session state, and sends the ICRQ message back to the active LNS;

step B14, the active LNS processes the ICCN message sent back by the standby LNS.

The SCCRQ message, SCCRP message, SCCCN message, ICRQ message, ICRP message, ICCN message, a request for establishing an L2TP tunnel by the opposite-end device and a response of L2TP establishment success, etc. in the embodiment of the disclosure are all L2TP control messages, and the L2TP control messages in the embodiment of the disclosure further include messages of the active and standby device performing a session and other communication with the opposite-end device.

The embodiments of the disclosure disclose a method for keeping alive an L2TP tunnel state, and through the process of an active device establishing an L2TP tunnel with an opposite-end device, and before the active device sends to the opposite-end device an L2TP control message, or before the active device processing the L2TP control message sent by the opposite-end device, the active device will always send to the standby device an L2TP control message with a serial number, and after storing the L2TP control message, the standby device then returns the L2TP control message to an active and standby device, and after receiving the L2TP control message, the active and standby device then performs other processing. L2TP control messages of an active device, a standby device and an opposite-end device in the embodiments of the disclosure always keep synchronous, ensuring that after switching between the active and standby device, the standby device and the opposite-end device may work normally, which will not cause discarding of the message, and ensuring the normal working state.

### Embodiment 2

The embodiments of the disclosure provide an apparatus for keeping alive an L2TP tunnel state, and the apparatus includes:

an active device, configured to establish an L2TP tunnel with an opposite-end device, transmit to a standby device an interactive L2TP control message between the active device and the opposite-end device, and perform corresponding processing on the L2TP control message only after having received a response about having already stored the L2TP control message sent by the standby device, and monitor network connectivity of the L2TP tunnel established between the active device and the opposite-end device, and when the L2TP tunnel is monitored to have a failure, trigger the standby device to switch with itself; and further configured to send to the standby device a request for establishing the L2TP tunnel with the opposite-end device, and after receiving a response about having stored the request sent by the standby device, send the request to the opposite-end device, and after receiving information about having successfully established the L2TP tunnel sent by the opposite-end device, send the information to the standby device, and receive a response of the standby device having stored the information;

the standby device, configured to the active device a response about having stored the L2TP control message after receiving and storing the L2TP control message sent by the active device, and when active-standby switching occurs between the standby device and the active device, connect to the opposite-end device via the L2TP tunnel, and performing corresponding processing according to the L2TP control message which has already been stored; and further configured to the active device a response about having stored the request after receiving and storing the request sent by the active device, and send to the active device a response about having stored the information after receiving and store information about having successfully established the L2TP tunnel sent by the active device.

In the embodiment of the information, the active device is an L2TP access concentrator or an L2TP network server; and the standby device is an L2TP access concentrator or an L2TP network server.

Each of the L2TP control messages in the embodiment of the disclosure carries a corresponding serial number.

The standby device, further configured to update states of the L2TP tunnel and a session on the standby device, when the standby device stores the L2TP control message sent by the active device.

In conclusion, the embodiments of the disclosure disclose a method and apparatus for keeping alive an L2TP tunnel state, and through the process of an active device establishing an L2TP tunnel with an opposite-end device, and before the active device sends to the opposite-end device an L2TP control message, or before the active device processing the L2TP control message sent by the opposite-end device, the active device will always send to the standby device an L2TP control message with a serial number, and after storing the L2TP control message, the standby device then returns the L2TP control message to an active and standby device, and after receiving the L2TP control message, the active device and the standby device then perform other processing, that is, L2TP control messages of an active and standby device and an opposite-end device in the embodiments of the disclosure always keep synchronous, ensuring that after switching between the active and standby device, the standby device and the opposite-end device can work normally, which will not cause discarding of the message, and ensuring the normal working state.

The foregoing descriptions are merely exemplary implementation manners of the disclosure, but the protection scope of the disclosure is not limited here. Any variation or replacement that may be easily thought of by persons skilled in the art without departing from the technical scope disclosed in the disclosure shall fall within the protection scope of the disclosure. Therefore, the protection scope of the disclosure shall be subject to the protection scope of the claims.

### INDUSTRIAL APPLICABILITY

The technical solutions provided in the embodiments of the disclosure may be applied in the field of switching an active and standby device, and they solve the problem of working state being chaotic caused by switching of an active and standby device.

1. A method for keeping alive an L2TP tunnel state, comprising:
an active device establishing an L2TP tunnel with an opposite-end device, the active device transmitting to the standby device an interactive L2TP control message between the active device and the opposite-end device, and the active device performing corresponding processing on the L2TP control message only after having received a response about having stored the L2TP control message sent by the standby device;
and when active-standby switching occurs between the active device and the standby device, the standby device connecting to the opposite-end device via the L2TP tunnel, and performing corresponding processing according to the L2TP control message which has already been stored.

2. The method according to claim 1, wherein the active device establishing the L2TP tunnel with the opposite-end device comprises:
the active device sending to the standby device a request for establishing the L2TP tunnel with the opposite-end device;
the standby device receiving and storing the request sent by the active device, and sending to the active device a response about having stored the request;
and after receiving the response about having stored the request sent by the standby device, the active device sending the request to the opposite-end device, and after receiving information about having successfully established the L2TP tunnel sent by the opposite-end device, sending the information to the standby device for storing.

3. The method according to claim 1, wherein the active device is an L2TP access concentrator or an L2TP network server; and the standby device is an L2TP access concentrator or an L2TP network server.

4. The method according to claim 1, wherein each of the L2TP control messages carries a corresponding serial number.

5. The method according to claim 1, wherein the standby device updates states of the L2TP tunnel and a session on the standby device, when the standby device stores the L2TP control message sent by the active device.

6. An apparatus for keeping alive an L2TP tunnel state, comprising:
an active device, configured to establish an L2TP tunnel with an opposite-end device, and transmit to the standby device an interactive L2TP control message between the active device and the opposite-end device, and perform corresponding processing on the L2TP control message only after having received a response about having already stored the L2TP control message sent by the standby device;
the standby device, configured to send to the active device a response about having stored the L2TP control message after receiving and storing the L2TP control message sent by the active device, and when active-standby switching occurs between the standby device and the active device, connecting to the opposite-end device via the L2TP tunnel, and performing corresponding processing according to the L2TP control message which has already been stored.

7. The apparatus according to claim 6, wherein
the active device, further configured to send to the standby device a request for establishing the L2TP tunnel with the opposite-end device, and after receiving a response about having stored the request sent by the standby device, send the request to the opposite-end device, and after receiving information about having successfully established the L2TP tunnel sent by the opposite-end device, send the information to the standby device, and receive a response about the standby device having stored the information;
and the standby device, further configured to send to the active device a response about having stored the request after receiving and storing the request sent by the active device, and sending to the active device a response about having stored the information after receiving and storing information about having successfully established the L2TP tunnel sent by the active device.

8. The apparatus according to claim 6, wherein the active device is an L2TP access concentrator or an L2TP network server; and the standby device is an L2TP access concentrator or an L2TP network server.

9. The apparatus according to claim 6, wherein each of the L2TP control messages carries a corresponding serial number.

10. The apparatus according to claim 6, wherein
the standby device, further configured to update states of the L2TP tunnel and a session on the standby device, when the standby device stores the L2TP control message sent by the active device.
